(19) United States
(12) Patent Application Publication
(10) Pub. No.: US 2025/0346217 A1
(43) Pub. Date: Nov. 13, 2025

(54) METHOD FOR BRAKING A MULTI-PART VEHICLE, IN PARTICULAR A COMMERCIAL VEHICLE, CONTROL DEVICE FOR A TRAILER, TRAILER, COMPUTER PROGRAM AND/OR COMPUTER-READABLE MEDIUM

(71) Applicant: ZF CV Systems Global GmbH, Bern (CH)

(72) Inventors: Steffen Gerlach, Hannover (DE); Michael Schomburg, Barsinghausen (DE); Axel Stender, Hameln (DE); Alexander Rodenberg, Braunschweig (DE)

(21) Appl. No.: 19/272,816

(22) Filed: Jul. 17, 2025

Related U.S. Application Data
(63) Continuation of application No. PCT/EP2023/086664, filed on Dec. 19, 2023.

(30) Foreign Application Priority Data
Jan. 17, 2023 (DE) 10 2023 100 931.1

(51) Int. Cl. B60T 8/17

(52) U.S. Cl. CPC B60T 8/1708

(57) ABSTRACT

In a method for braking a multi-part vehicle including a commercial vehicle having a tractor and two trailers each having an electrically actuatable brake modulator, a braking request to brake the vehicle, in particular the commercial vehicle, is detected. By using the braking request, actuating signals for the time-offset actuation of the brake modulators are determined. The actuating signals for the asynchronous actuation of the brake modulators are output.

### CROSS-REFERENCE TO RELATED APPLICATIONS

This application is a continuation application of international patent application PCT/EP2023/086664, filed Dec. 19, 2023, designating the United States and claiming priority from German application 10 2023 100 931.1, filed Jan. 17, 2023, and the entire content of both applications is incorporated herein by reference.

### TECHNICAL FIELD

The present disclosure relates to a method for braking a multi-part vehicle, in particular a commercial vehicle, having a tractor and two trailers each having an electrically actuatable brake modulator. The disclosure also relates to a controller for a trailer of a multi-part vehicle, in particular a commercial vehicle, including a tractor and two trailers, to a trailer and to a computer program and/or computer-readable medium.

### BACKGROUND

Methods for braking such a multi-part vehicle are known from the prior art. The tractor includes an electromechanical and/or electropneumatic braking system (electronic braking system, EBS), and the trailer or trailers each include a trailer braking system (trailer electronic braking system, TEBS). In order to brake the units, that is, the tractor and one or more trailers, of the multi-part vehicle (train, “road train”), the use of multiple TEBS on different axle units and/or trailer modules is necessary.

A TEBS for commercial vehicle trailers according to the prior art supports trains with up to 10 trailers. A trailer arranged in the center of the train, that is, between the tractor and a last trailer, has a CAN router and/or CAN repeater for forwarding a braking signal to a following vehicle unit, in addition to the corresponding electrical and pneumatic equipment. The braking signal is transmitted to a so-called brake modulator for the braking. The brake modulator includes one or more solenoid valves, which can be controlled by using the braking signal in order to effect the braking.

US 2018/0001877 discloses a brake modulator for a compressed air braking system of a vehicle.

The CAN router effects the supply of the brake modulators with CAN signals, for example according to ISO 11992. A braking request is distributed to the brake modulators as a CAN braking signal via the CAN router and/or CAN repeater, starting, for example, from the tractor.

The primary advantage of using an EBS or TEBS in such a trailer train is the possibility of simultaneous initiation of the braking in all the vehicle units by transmitting a target pressure according to the braking request via the CAN bus.

As distinct from conventional braking systems, in which the braking request is conducted to the trailer or trailers from the tractor in the form of air pressure and in which, as a result of the limited speed of propagation of the air pressure, there is a delay in the braking, in particular in the rear trailers, it is not possible for any dangerous shunting situations to occur. Furthermore, the response time of the TEBS during braking as compared with a conventional braking system is shortened by the electrical signal transmission.

However, the exactly simultaneous response of the brakes or other brake modulators in multiple and/or all the trailers necessitates high peak current values, in particular if all the brake controllers or brake modulators are of the same type and/or the same configuration. As a result of the voltage drop that is produced, this can lead to the rear trailer vehicles no longer receiving an adequate voltage and the solenoid valves in the TEBS for the braking no longer being able to be attracted, or bringing the power supply in the tractor to its power limit and thus causing a risk of malfunctions.

### SUMMARY

It is an object of the disclosure to enable more reliable braking of a multi-part vehicle.

The object is, for example achieved by a method for braking a multi-part vehicle having a tractor and two trailers each having an electrically actuatable brake modulator. The method includes: detecting a braking request to brake the vehicle; by using the braking request, determining actuating signals for a time-offset actuation of the brake modulators; and, outputting the actuating signals for asynchronous actuation of the brake modulators.

The object is, for example, also achieved by various controllers, trailers, and computer programs according to the disclosure.

According to the disclosure, a method for braking a multi-part vehicle, in particular a commercial vehicle, having a tractor and two trailers each having an electrically actuatable brake modulator is provided. The method includes: detecting a braking request to brake the vehicle, in particular the commercial vehicle; on the basis of the braking request, determining actuating signals for the time-offset actuation of the brake modulators; and outputting the actuating signals for the asynchronous actuation of the brake modulators.

The braking request is detected in order to define a braking procedure for the braking. The braking request can, for example, be triggered by a driver of the vehicle and/or by an automatic driving function, and request the braking of the vehicle. The braking request can be triggered by the tractor and/or by a trailer or the braking system of the latter, in order, for example, to be able to carry out a braking intervention to improve driving stability.

The braking request can define the actuating signals. The actuating signals can be, for example, signals to be transmitted from a CAN router to the brake modulators. Each of the brake modulators can receive one of the actuating signals in order to actuate the braking device of the respective trailer that is connected to the brake modulator. The actuating signal can thus include information for operating the respective brake module for each of the brake modulators and/or each of the trailers on the basis of the braking request.

It has been recognized that the actuating signals can be output in such a way that the brake modulators are operated asynchronously. The actuating signals are thus signals determined for the time-offset actuation of the brake modulators. This can be done via the time-separated output of an otherwise identical braking signal and/or by the output of a braking signal with time information for operating the corresponding brake modulator. Therefore, a reduction in a peak current value is possible as a result of a defined asynchronous initiation of the braking in the various trailers. As a result of the electrical output of the actuating signals, a time offset between different brake modulators can at the same time be kept so low that there are no noticeable negative consequences for the braking procedure in the overall system, that is, in the entire vehicle.

Optionally, the braking request is transmitted to the trailers via a vehicle bus, and one of the actuating signals for actuating the brake modulator of one of the trailers is determined by a controller of the respective trailer. It is thus possible for the braking request to be able to be transmitted to the controllers of the trailers in order to be converted locally by the respective controller into one of the actuating signals. Each of the controllers can define an actuation of the respective brake modulator asynchronously to the braking request.

Optionally, one of the actuating signals for actuating the brake modulator of one of the trailers is determined as a function of an address relating to the trailer and/or a position of the trailer. It has been recognized that each brake modulator and/or each controller controlling one of the brake modulators can be controlled asynchronously by using the position and/or the address. The position can define the position of the trailer in the multi-part vehicle. The address can be information defining and/or identifying the trailer. The position and/or address of the trailer in the trailer train can be known to the respective controller from CAN messages from the router.

Optionally, the braking signals are determined in such a way that a trailer leading in a direction of travel is braked later than a trailer trailing in the direction of travel. The delay time for the asynchronous actuation can be chosen to brake the last trailers earlier and thus to ensure a stretched train. Alternatively, it is possible that the braking signals are determined in such a way that a trailer leading in a direction of travel is braked earlier than a trailer trailing in the direction of travel.

Optionally, the braking signals are determined in such a way that only the brake modulator of exactly one of the trailers actuates a solenoid valve in an attraction phase at one point in time. It has been recognized that, in the attraction phase, also called the push phase, comparatively short actuation of the solenoid valve of the brake modulator is carried out with a comparatively high supply voltage and/or with a comparatively high supply current, for example in the microsecond range. The attraction phrase can, for example, last for 10 ms to 50 ms. Alternatively, in the attraction phase, pulse width modulation with an increased turn-on time and therefore an increased current can be carried out. If only one solenoid valve, for example per brake modulator and/or per trailer, is simultaneously in the attraction phase, an excessively high current peak can effectively be avoided.

Optionally, the braking signals are determined in such a way that a time offset between attraction phases of the brake modulators is 1 ms to 30 ms. If the time offset is, for example, 20 ms or a value in the range mentioned above, current peaks can effectively be reduced and, at the same time, fast response of the brakes can be maintained.

Optionally, the braking signals are determined in such a way that a time offset between attraction phases of the brake modulators meets a threshold value condition and/or falls below a threshold value. The threshold value condition can, for example, be defined by a statutory and/or security-relevant provision and/or standard. The threshold value condition can be defined by the threshold value below which it must not fall. In order that the current peaks can be reduced effectively, the threshold value condition can define a minimum time offset.

According to one aspect of the disclosure, a controller for a trailer of a multi-part vehicle, in particular a commercial vehicle, having a tractor and two trailers is provided. The controller is configured to carry out the above-described method. Optionally, the controller is configured to carry out a method step described as optional, in order to achieve an associated technical effect.

According to one aspect of the disclosure, a trailer including an electrically actuatable brake modulator is provided. The trailer includes the above-described controller. Optionally, the trailer is configured to carry out a method step described as optional, in order to achieve an associated technical effect.

According to one aspect of the disclosure, a computer program and/or a computer-readable medium are provided. The computer program and/or the computer-readable medium include/s commands which, during the execution of the program or the commands by a computer, cause the latter to carry out the above-described method and/or steps thereof. Optionally, the computer program and/or the computer-readable medium include/s commands which, when the program or the commands are executed by a computer, cause the latter to carry out a method step described as optional, in order to achieve an associated technical effect.

### BRIEF DESCRIPTION OF DRAWINGS

The invention will now be described with reference to the drawings wherein:

FIG. 1 shows a schematic illustration of a multi-part vehicle, in particular a commercial vehicle, having a trailer according to an embodiment of the disclosure;

FIG. 2 shows a schematic illustration each of a voltage and current characteristic curve of a brake modulator for a trailer according to an embodiment of the disclosure;

FIG. 3 shows a schematic illustration each of a voltage and current characteristic curve of two brake modulators and a resultant voltage and current characteristic curve for a vehicle according to the prior art;

FIG. 4 shows a schematic illustration each of a voltage and current characteristic curve of two brake modulators and a resultant voltage and current characteristic curve for a vehicle according to an embodiment of the disclosure; and,

FIG. 5 shows a schematic sequence of a method according to an embodiment of the disclosure.

### DETAILED DESCRIPTION

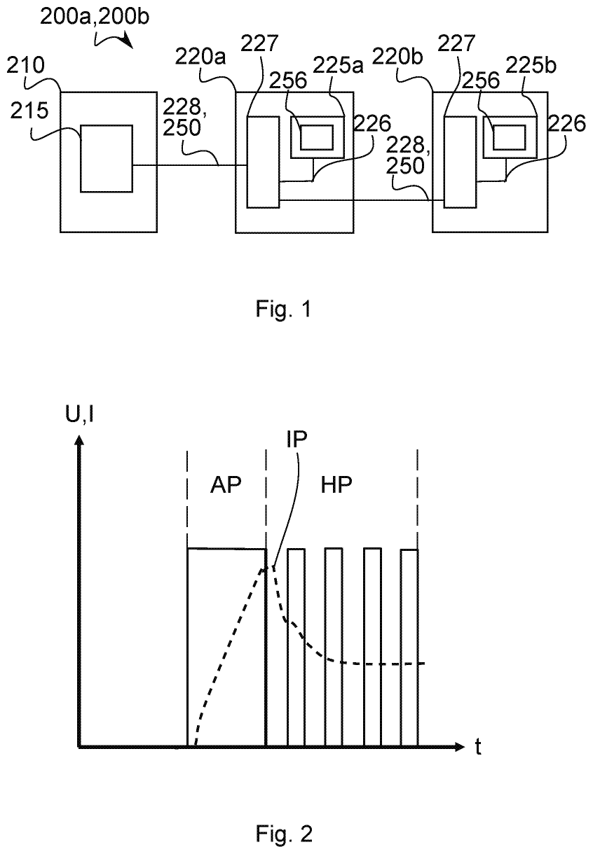

FIG. 1 shows a schematic illustration of a multi-part vehicle 200a, in particular a commercial vehicle 200b, including a trailer 220a, 220b according to an embodiment of the disclosure. The multi-part vehicle 200a, in particular the commercial vehicle 200b, is an in particular rail-bound land vehicle. In the embodiment shown, the multi-part vehicle 200a, in particular the commercial vehicle 200b, includes a tractor 210 (also: truck) and two trailers (220a, 220b), that is, a first trailer 220a and a second trailer 220b. The second trailer 220b can be pulled by the first trailer 220a. In another embodiment (not shown), the multi-part vehicle 200a, in particular the commercial vehicle 200b, can have one or more than two trailers 220a, 220b.

The tractor 210 includes a central controller 215. The central controller 215 is configured to detect a braking request 250. For this purpose, the central controller 215 is, for example, connected to a braking value transmitter (not shown) and/or is configured to carry out an automatic driving function, in order to detect a request relating to braking the vehicle 200a, 200b.

The central controller 215 is configured to transmit the braking request 250 to the trailers 220a, 220b of the vehicle 200a, 200b. For this purpose, the central controller 215 can ask for an address 228 from each of the trailers 220a, 220b. For this purpose, the central controller 215 is connected directly to the first trailer 220a via a vehicle bus, for example a CAN bus, and to the second trailer 220b via the first trailer 220a.

Each of the trailers 220a, 220b includes a controller 227 and a brake modulator 225a, 225b, each having a plurality of solenoid valves 256 (in each case only one solenoid valve 256 is shown for the purpose of illustration).

The controller 227 of the first trailer 220a is configured to receive the braking request 250 from the tractor 210. For this purpose, the controller 227 has a vehicle bus interface (not shown). The controller 227 of the first trailer 220a is configured to determine an actuating signal 226 by using the braking request 250 and to transmit the signal to the brake modulator 225a of the first trailer 220a, and to operate the brake modulator 225a in order to actuate the solenoid valve 256, and thus ultimately to trigger the braking requested by the braking request 250. The controller 227 of the first trailer 220a is configured to transmit the braking request 250 from the tractor 210 to the second trailer 220b.

Analogously, the controller 227 of the second trailer 220b is configured to receive the braking request 250 from the first trailer 220a. For this purpose, the controller 227 has a vehicle bus interface (not shown). The controller 227 of the second trailer 220b is configured to determine an actuating signal 226 by using the braking request 250 and to transmit the signal to the brake modulator 225b of the second trailer 220b and to operate the brake modulator 225b in order to actuate the solenoid valve 256 and thus ultimately to trigger the braking requested by the braking request 250.

The actuating signals 226 are determined by the controllers 227 in such a way that the brake modulators 225a, 225b are actuated with a time offset, as described with reference to FIG. 4. Therefore, the controllers 227 output the actuating signals 226 relating to asynchronous actuation of the brake modulators 225a, 225b.

When the braking request 250 is detected by the vehicle or by the trailer, the braking request 250 can be transmitted in such a way that the actuating signals 226 are output by the controller 227 of the respective trailer 220a, 220b at different times, in order to actuate the brake modulators 225a, 225b with a time offset. This means that the braking request 240 is processed by each of the controllers 227 and already includes the information relating to the time-offset determination and output of the actuating signal 226, for example for each address 228 of the trailer 220a, 220b.

Alternatively or additionally, by using the braking request 240, in each case an actuating signal 227 can be determined via the controller 227 of the respective trailer 220a, 220b and output in such a way that the actuating signals 226 for controlling the brake modulators 225a, 225b are provided at different times, that is, with a time offset. This means that the braking request 240 is processed by each of the controllers 227 and the braking request 240 is implemented by the controller 227, for example depending on the address 228 of the trailer 220a, 220b, with a time offset DT and the actuating signal 226 is output in accordance with the time offset DT.

FIG. 2 shows a schematic illustration each of a voltage and current characteristic curve of a brake modulator 225a, 225b for a trailer 220a, 220b according to an embodiment of the disclosure. FIG. 2 will be described with reference to FIG. 1.

The voltage U is plotted against the time t and illustrated by a continuous line. A current I corresponding to the voltage U is plotted against the time t with a dashed line.

According to the characteristic curves in FIG. 2, the actuation of a brake modulator 225a, 225b and its solenoid valves 256 can be subdivided into two phases. A start of an actuation phase AP is marked by a first vertical dashed line. The actuation phase AP is also called a push phase or forced control phase and defines a comparatively very short actuation of the solenoid valves 256 with the full supply voltage U in the microsecond range. In the process, the current I rises as far as a current peak IP at an end of the actuation phase AP marked by a second vertical dashed line.

The actuation phase AP is followed by a holding phase HP. The holding phase HP begins when an armature of the respective solenoid valve 256 has reached an end position. Then, pulse width modulation can be performed, the supply voltage U being switched off and on cyclically. This results in a reduction in the current with respect to the current peak IP.

In an embodiment that is not shown, a further phase can also occur between the actuation phase AP and the holding phase HP, in which the control is provided with pulse width modulation with a turn-on time that is increased as compared with the holding phase HP and therefore with an increased current.

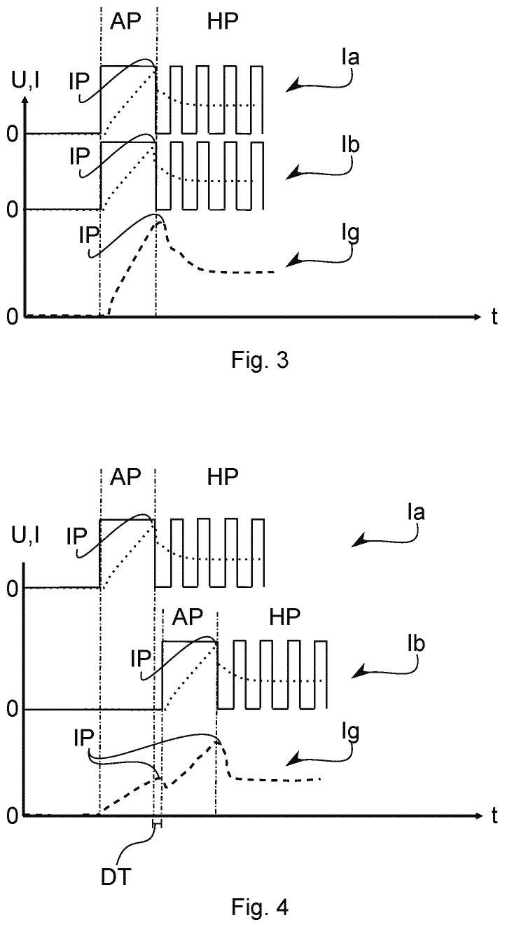

FIG. 3 shows a schematic illustration each of a voltage and current characteristic curve of two brake modulators 225a, 225b and a resultant voltage and current characteristic curve for a vehicle 200a, 200b according to the prior art. FIG. 3 will be described with reference to FIGS. 1 and 2.

FIG. 3 shows schematically a voltage and characteristic curve each, as described with reference to FIG. 2, spaced apart vertically at the top and center. In particular, the upper current curve shows the current Ia of a first brake modulator 225a, and the current curve drawn below that shows the current Ib of a second brake modulator 225b, each as a function of the time t. FIG. 3 additionally shows, at the bottom, a total current Ig as the sum of the current Ia of the first brake modulator 225a and of the current Ib of the second brake modulator 225b.

The current I adds up to a maximum at the current peak IP, since the current peak IP of the current Ia of the first brake modulator 225a and the current peak IP of the current Ib of the second brake modulator 225b coincide in time. The exactly simultaneous response of the brakes in all the trailers 220a, 220b thus necessitates high peak current values; above all if all the controllers 227 and brake modulators 225a, 225b are of the same type. This can bring the power supply in the tractor 210 to its power limit.

FIG. 4 shows a schematic illustration each of a voltage and current characteristic curve of two brake modulators and a resultant voltage and current characteristic curve for a vehicle 200a, 200b according to an embodiment of the disclosure.

FIG. 4 shows schematically a voltage and characteristic curve each, as described with reference to FIG. 2, spaced apart vertically at the top and center. In particular, the upper current curve shows the current Ia of a first brake modulator 225a, and the current curve drawn below that shows the current Ib of a second brake modulator 225b, each as a function of the time t. FIG. 4 additionally shows, at the bottom, a total current Ig as the sum of the current Ia of the first brake modulator 225a and of the current Ib of the second brake modulator 225b.

The brake modulators 225a, 225b are actuated in accordance with the braking signals 226 in such a way that only the brake modulator 225a, 225b of exactly one of the trailers 220a, 220b actuates a solenoid valve 256 in an attraction phase AP at one point in time. Therefore, there is a time offset DT between the attraction phases AP of the brake modulators 225a, 225b. The time offset DT is, for example, 1 ms to 30 ms.

As described with reference to FIG. 3, there can be high current peaks IP when a plurality of solenoid valves 256 are in the attraction phase AP at the same time. However, it can be seen from FIG. 4 that even a small time offset DT is sufficient to rectify the situation and to flatten the current peak IP. There is always only one solenoid valve 256 in the attraction phase AP, and other solenoid valves 256 are not yet actuated or are in the holding phase HP. The asynchronous actuation can be carried out in such a way that no overlap of the actuation phases AP is produced.

The offset DT does not have to be set for all of the, for example, four to five solenoid valves 256 per controller 227; even with asynchronous actuation of two solenoid valves 256, there are nevertheless low peak current values due to the asynchronous actuation.

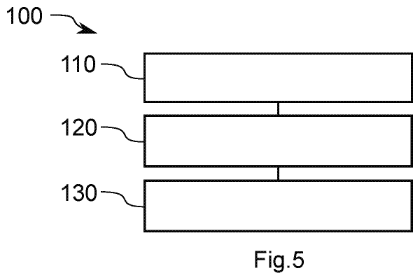

FIG. 5 shows a schematic sequence of a method 100 according to an embodiment of the disclosure. The method 100 is a method 100 for braking a multi-part vehicle 200a, in particular a commercial vehicle 200b, including a tractor 210 and two trailers 220a, 200b, each having an electrically actuatable brake modulator 225a, 225b. Such a vehicle 200a, 200b and its brake modulators 225a, 225b have been described with reference to FIGS. 1, 2 and 4.

The method 100 includes: detecting 110 a braking request 250 to brake the vehicle 200a, 200b.

The braking request 250 is transmitted to the trailers 220a, 220b via a vehicle bus 205.

By using the braking request 250, a determination 120 is made of actuating signals 226 for the time-offset actuation of the brake modulators 225a, 225b.

One of the actuating signals 226 for actuating the brake modulator 225a, 225b of one of the trailers 220a, 200b is determined by a controller 227 of the respective trailer 220a, 220b. One of the actuating signals 226 for actuating the brake modulator 225a, 225b of one of the trailers 220a, 220b is determined as a function of an address 228 relating to the trailer 220a, 220b and/or a position 229 of the trailer 220a, 220b. The position of the trailers 220a, 220b in the multi-part vehicle 200a, 200b or in the trailer train is known to the respective controller 227 from the CAN messages from a CAN router and/or a central controller 215 of the tractor 210.

The braking signals 226 are determined in such a way that a trailer 220a leading in a direction of travel F is braked later than a trailer 220b trailing in the direction of travel F. The time offset implies a specific delay time between the actuation of different brake modulators 225a, 225b. The delay time can deliberately be chosen in such a way as to brake the last trailers 220b somewhat earlier than a forward trailer 220a and thus to achieve a stretched train.

The braking signals 226 are determined in such a way that only the brake modulator 225a, 225b of exactly one of the trailers 220a, 220b actuates a solenoid valve 256 in an attraction phase AP at one point in time. The braking signals 226 are determined in such a way that a time offset DT between attraction phases AP of the brake modulators 225a, 225b is 1 ms to 30 ms. The braking signals 226 are determined in such a way that a time offset DT between attraction phases AP of the brake modulators 225a, 225b meets a threshold value condition and/or falls below a threshold value.

The actuating signals 226 for the asynchronous actuation of the brake modulators 225a, 225b are output 130. The asynchronous actuation designates the specific provision of a delay time between actuations of the brake modulators 225a, 225b.

In order to cause the delay of the braking request 250 by one of the controllers 227 of the trailers 220a, 220b in conformity with requirements, for example of a conformity test on the time response, the inherent time response of the respective trailer 220a, 220b itself can be assessed, since the braking request 250 is present in the same way at every location in the vehicle 200a, 200b via the CAN bus. In this way, the delay of the braking request 250 can be limited in such a way that the requirements relating to the time response are maintained, that is, meet the threshold value condition. Alternatively or additionally, a result of the measurement from a measuring device for conformity tests can be fed back into the controller 227 via computer-aided diagnosis, and the delay or the time offset DT can be chosen accordingly by the controller 227.

It is understood that the foregoing description is that of the preferred embodiments of the invention and that various changes and modifications may be made thereto without departing from the spirit and scope of the invention as defined in the appended claims.

### LIST OF REFERENCE SYMBOLS (PART OF THE DESCRIPTION)

100 Method
110 Detection
120 Determination
130 Output
200a Vehicle
200b Commercial vehicle
205 Vehicle bus
210 Tractor
215 Central controller
220a Trailer
220b Trailer
225a first brake modulator
225b second brake modulator
226 Actuating signal
227 Controller
228 Address
250 Braking request
256 Solenoid valve
AP Attraction phase
DT Time offset
HP Holding phase
IP Current peak
Ia Current of a first brake modulator
Ib Current of a second brake modulator
Ig Total current
F Direction of travel
t Time

1. A method for braking a multi-part vehicle having a tractor and two trailers each having an electrically actuatable brake modulator, wherein the method comprises:
detecting a braking request to brake the vehicle;
by using the braking request, determining actuating signals for a time-offset actuation of the brake modulators; and,
outputting the actuating signals for asynchronous actuation of the brake modulators.

2. The method of claim 1, wherein:
the braking request is transmitted to the trailers via a vehicle bus; and,
one of the actuating signals for actuating the brake modulator of one of the trailers is determined by a controller of the respective trailer.

3. The method of claim 1, wherein one of the actuating signals for actuating the brake modulator of one of the trailers is determined as a function of at least one of the following: i) an address relating to the trailer; and, ii) a position of the trailer.

4. The method of claim 1, wherein the braking signals are determined in such a way that a trailer leading in a direction of travel is braked later than a trailer trailing in the direction of travel.

5. The method of claim 1, wherein the braking signals are determined in such a way that only the brake modulator of exactly one of the trailers actuates a solenoid valve in an attraction phase at one point in time.

6. The method of claim 1, wherein the braking signals are determined in such a way that a time offset between attraction phases of the brake modulators is 1 ms to 30 ms.

7. The method of claim 1, wherein the braking signals are determined in such a way that a time offset between attraction phases of the brake modulators meets a threshold value condition or falls below a threshold value.

8. A controller for a trailer of a multi-part vehicle having a tractor and two trailers, wherein the controller is configured to carry out the method of claim 1.

9. A trailer comprising:
an electrically actuatable brake modulator; and,
a controller configured to:
detect a braking request to brake a vehicle;
by using the braking request, determine actuating signals for a time-offset actuation of the electrically actuatable brake modulator; and,
output the actuating signals for asynchronous actuation of the electrically actuatable brake modulator.

10. A computer program and/or computer-readable medium, comprising commands stored on a non-transitory computer readable medium, said commands being configured, when the program or the commands are executed by a computer, to cause the computer to:
detect a braking request to brake a vehicle;
by using the braking request, determine actuating signals for a time-offset actuation of brake modulators; and,
output the actuating signals for asynchronous actuation of the brake modulators.

11. The method of claim 1, wherein the multi-part vehicle is a commercial vehicle.

12. The controller of claim 8, wherein the multi-part vehicle is a commercial vehicle.
